(19) United States
(12) Patent Application Publication
(10) Pub. No.: US 2026/0178341 A1
(43) Pub. Date: Jun. 25, 2026

(54) SYSTEM AND METHOD OF MULTI-PHASE INITIALIZATION ON A NETWORK DEVICE

(71) Applicant: Arista Networks, Inc., Santa Clara, CA (US)

(72) Inventors: Peter Eduard Rufer, Palo Alto, CA (US); Hua Zhong, Los Altos, CA (US); Diego Alfredo Asturias, Mountain View, CA (US)

(21) Appl. No.: 19/000,195

(22) Filed: Dec. 23, 2024

(51) Int. Cl. G06F 9/4401

(52) U.S. Cl. CPC G06F 9/4406; G06F 9/4405

(57) ABSTRACT

A method for booting a computing device includes, during a boot sequence, launching a prefetcher from an operating system (OS) image for an OS, reading, by the prefetcher, a prefetcher list that specifies a plurality of files to be prefetched, and reading the plurality of files specified by the prefetcher list to cause the plurality of files to be copied from a filesystem to a file cache to prefetch the plurality of files for a startup of a user space process of the OS.

### TECHNICAL FIELD

This disclosure relates generally to initializing software. More particularly, this disclosure relates to multi-phase initialization of software.

### BACKGROUND

In a typical boot sequence for a computer, the basic input/output system (BIOS) or the Unified Extensible Firmware Interface (UEFI) performs power-on-self-test (POST) to confirm that hardware components are working properly, locates a bootloader and loads the bootloader into memory, the bootloader locates the operating system (OS) kernel and loads the kernel into memory, the kernel mounts a root file system, loads drivers and other kernel modules, and executes an initialization component (e.g., software initialization scripts, systemd system and service manager, or another initialization component), and the initialization component executes other user space processes of the OS.

Many OS distributions use a compressed file system, such as squashfs, as the root file system. As a user space process is executed, it may read various files from the compressed file system. The OS kernel decompresses the files to a file cache in volatile random-access memory (RAM) and services the calls from the file cache. Dependencies between user space processes may result in underutilization of the processor or I/O operations while one user space process waits for another process to finish initializing.

### BRIEF DESCRIPTION OF DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features.

FIG. 1 is a diagrammatic representation of one embodiment of a computing environment comprising a network device configured to boot using a prefetcher.

FIG. 2 is a diagrammatic representation of one embodiment of an operating system having a prefetcher prefetching files.

FIG. 3 is a flowchart illustrating one embodiment of a boot method.

FIG. 4 is a flowchart illustrating one embodiment of a prefetching method.

FIG. 5 is a diagrammatic representation of one embodiment of a network device.

FIG. 6A is a chart illustrating an example of timings without prefetching and FIG. 6B is a chart illustrating an example of timings using prefetching.

### DETAILED DESCRIPTION

Specific embodiments will now be described with reference to the accompanying figures (FIGS.). The figures and the following description describe certain embodiments by way of illustration only. One skilled in the art will readily recognize from the following description that alternative embodiments of the structures and methods illustrated herein may be employed without departing from the principles described herein. It is noted that wherever practicable similar or like reference numbers may be used in the figures and may indicate similar or like functionality.

Embodiments of the present disclosure provide systems and methods for multi-phase initialization on a network device or other computing device. An operating system (OS) image includes a prefetcher and a list of files to prefetch. At the initialization stage, the initialization component launches the prefetcher and other user space components of the OS. The prefetcher reads the list of files to be prefetched and reads the files specified by the list. The reading of the files by the prefetcher causes the files to be copied to a file cache for faster loading by the user space components. I The initialization component can launch the prefetcher early in the initialization stage when there is likely to be excess CPU and I/O capacity.

In some implementations, the initialization process has a relatively long initial phase that does not consume all of the CPU and I/O bandwidth. The prefetcher may be launched and prefetch files in parallel with other boot initializations running. By launching the prefetcher at or near the beginning of the boot process, embodiments can utilize CPU and I/O bandwidths that would otherwise be idle to thereby benefit later boot processes.

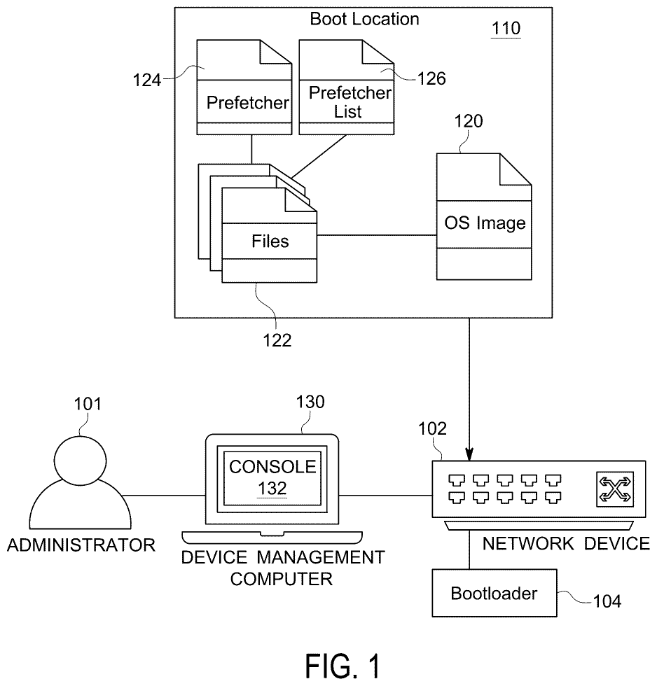

FIG. 1 is a diagrammatic representation of one embodiment of a computing environment comprising a network device 102 (e.g., a switch, a router, a gateway, a firewall device, or another network device) and a device management computer 130. As illustrated in FIG. 1, an administrator 101 may access an administrator console 132 on a device management computer 130 connected to a network device 102 and configure network device 102 with an OS image source 110 from which to load an OS image 120. In one embodiment, a startup-config file is stored to an internal flash memory of network device 102 and specifies the OS image source 110. Image source 110 may be a local source (e.g., an internal flash drive location, a USB drive location, or other local location) or a remote source (e.g., specified using an FTP path, a TFTP path, an NFS path, a URL, etc.). Bootloader 104 of network device 102 loads OS image 120 from the specified location during booting.

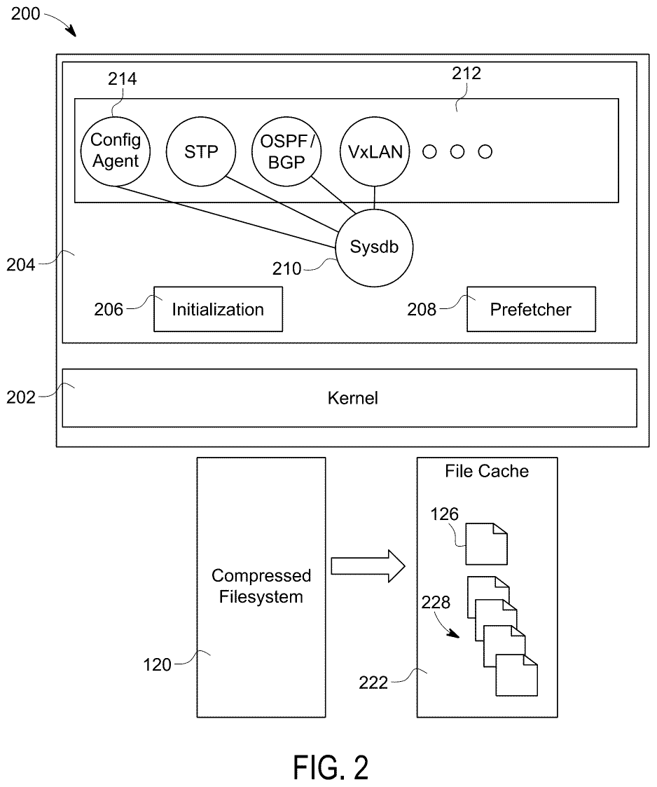

OS image 120 is a compressed file (e.g., a . zip file or other compressed file) that contains program files 122 (e.g., code files, configuration data files, etc.) of the OS kernel and user space processes. In an even more particular embodiment, OS image 120 is a compressed filesystem, such as a squashfs filesystem (squashfs is a compressed read-only filesystem). In particular, OS image 120 includes program files 124 for instantiating a prefetcher (e.g., prefetcher 208 of FIG. 2) and a prefetcher list 126 used by the prefetcher to prefetch files for other processes. According to one embodiment, prefetcher list 126 includes a list of filenames of files to prefetch. In an even more particular embodiment, the filenames in prefetcher list 126 are expressed as full paths.

During the boot sequence, the initialization component of the OS executes the prefetcher which, in turn, reads prefetcher list 126. The prefetcher reads the files listed in prefetcher list 126 to cause those files to be copied from the compressed filesystem to a file cache. Thus, when another user space process that is starting up calls a file, the file may already be in the file cache.

To provide additional context, FIG. 2 is a diagrammatic representation of one embodiment of an operating system 200 of a network device, such as network device 102. Operating system 200 includes a kernel 202 and user space processes 204. User space processes 204 include an initialization component 206, a prefetcher 208, Sysdb 210 and agents 212, including a ConfigAgent 214 and other agents. In one embodiment, initialization component 206 comprises a systemd system and service manager for Linux.

Kernel 202 provides core operating system functionality such as scheduling and base level system resource management. Sysdb 210 is a process that manages a centralized state repository (system database) that records configuration and operational state of agents 212. ConfigAgent 214 manages the configuration of the network device (e.g., network device 102) in real-time. Agents 212 also include agents to perform operations to implement Spanning Tree Protocol (STP), Open Shortest Path First (OSPF)/Border Gateway Protocol (BGP), Virtual eXtensible LAN (VxLAN), and Multi-Chassis Link Aggregation (MLAG) among other operations. Agents 212 may interact with Sysdb 210 to maintain and synchronize configurations across components. One or more agents may have to wait for Sysdb 210 to finish initializing before they can also finish initializing.

According to one embodiment, when the OS is being built, a trace of files that get loaded by the various user space processes of the OS (e.g., all the processes or processes of interest) is created (e.g., using strace). In one embodiment, an ordered list of file accesses is built to generate a prefetcher list 126 file to have a “perfect cache prefetcher.”

A perfect cache prefetcher is an idealized prefetching mechanism in computer systems that predicts future memory accesses with 100% accuracy and prefetches the exact data required into the cache before that data is accessed by the process that needs the data. A perfect prefetcher can potentially eliminate all cache misses of the data in the prefetch list providing maximum cache efficiency.

According to one embodiment, prefetcher 208 provides a perfect prediction memory access pattern. Prefetcher 208 knows exactly what files will be accessed in the future and can bring it into the cache just in time, so that the processor does not experience cache misses due to lack of data. Prefetcher 208 can avoid over fetching or under fetching, only loading what will actually be used to the cache.

Thus, the list of files loaded by processes of interest and the order in which they are loaded can be determined. The list of files can be stored as part of the software image (e.g., OS image 120) as one or more prefetcher list files. Thus, for example, if Sysdb 210 and ConfigAgent 214 are the processes of interest, a list of files that will be loaded by Sysdb 210 and ConfigAgent 214 can be stored as part of OS image 120 for use by prefetcher 208.

The files to be prefetched may be ordered in a variety of manners. In some cases, the list of files to prefetch is ordered based on the order in which the files were loaded by the processes of interest as recorded when the OS is built. The filenames may be ordered, in some embodiments, in a process sequential manner (e.g., the files to be prefetched for a first process are listed first, the files to be prefetched for a second process are listed next and so on. Loading in a process sequential manner may be particularly useful when a second process (P2) has a dependency on a first process (P1) so that prefetching of the files needed by the second process (P2) does not slow down the startup of the first process P1.

Operating system 200 is booted from OS image 120, which uses a read-only compressed file system (e.g., a squashfs file). Kernel 202 is loaded and executes initialization component 206 (e.g., software initialization scripts, systemd system and service manager, or another initialization component) and initialization component 206 launches prefetcher 208, which reads prefetcher list 126 that includes a list of files to prefetch. When prefetcher 208 makes calls to kernel 202 to read the file(s) that embody list 126, kernel 202 copies the files from the compressed file system of OS image 120 to a file cache 222 (e.g., in volatile memory) and responds to the calls from prefetcher 208 from file cache 222. As prefetcher reads a file specified by prefetcher list 126, kernel 202 services the calls for the file from cache 222 if the file is already in cache 222 or, if the file is not already in file cache 222, copies the requested file from the compressed file system of OS image 120 to a file cache 222 and responds to the calls from prefetcher 208 from file cache 222. Consequently, file cache 222 may include files 228 read by prefetcher 208 (or other user space process).

Initialization component 206 may also launch other user space processes, such as Sysdb 210 and ConfigAgent 214 (or other agents). As the user space process reads a file that it uses in its startup process, kernel 202 services the calls for the file from cache 222 if the file is already in cache 222 or, if the file is not already in file cache 222, copies the requested file from the compressed file system of OS image 120 to a file cache 222 and responds to the calls from the user space process from file cache 222. For example, if Sysdb 210 requests to read a file that is already in cache 222 (e.g., a file 228), kernel 202 services the calls for the file from cache 222. If the file is not already a cached file 228, kernel 202 copies the requested file from the compressed file system of OS image 120 to file cache 222 and responds to Sysdb 210 from file cache 222.

Initialization component 206 can be configured to launch prefetcher 208 before launching other user space processes that use the files to be prefetched by prefetcher 208. For example, systemd can be configured with dependencies and orders of the processes to be launched. Moreover, prefetcher can be a very lightweight process that, according to one embodiment, iterates through the list of files to be prefetched and makes calls to read those files to cause kernel 202 to copy the files to file cache 222, but does not have to otherwise process the prefetched files. Thus, prefetcher 208 can move quickly through its list of files to be prefetched. Consequently, the files used during the initialization of other processes such as Sysdb 210 and ConfigAgent 214 may already be in file cache 222 when those processes call the files allowing the calls to be quickly serviced.

Thus, when operating system 200 is booting up, initialization component 206 executes prefetcher 208, which then reads the files needed by other processes of interest (e.g., Sysdb 210 and ConfigAgent 214 as an example). The act of reading the files will decompress the files from OS image 120 and populate file cache 222. When Sysdb 210 and ConfigAgent 214 then need the files, the files will load faster since they are in file cache 222.

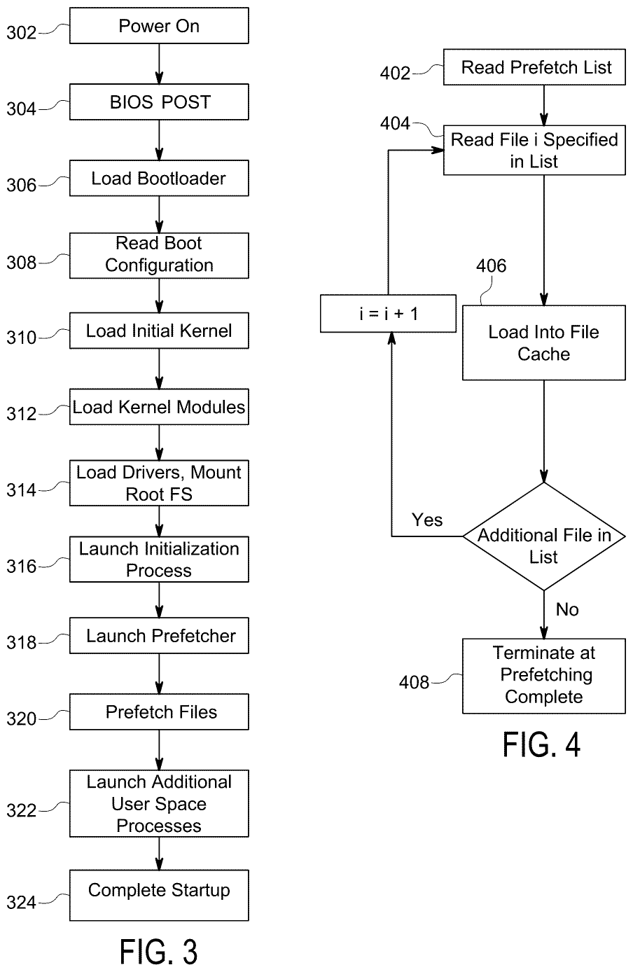

FIG. 3 is a flow chart illustrating one embodiment of booting an operating system of a computer system. At step 302, the computing system powers on. At step 304, the BIOS performs initial hardware checks and, at step 306, loads the bootloader. The bootloader, at step 308, reads a boot configuration. The boot configuration includes which OS software image to boot. At step 310, the bootloader loads the initial kernel components from the OS software image (e.g., OS image 120). The initial kernel components, at step 312, perform a self-extraction of the kernel loading other kernel modules from the OS software image. The kernel (e.g., kernel 202), at step 314, performs additional kernel processing, such as mounting a compressed read-only root file system and loading drivers. The kernel, at step 316, executes an initialization component (e.g., initialization component 206). The initialization component, at step 318, launches a prefetcher (e.g., prefetcher 208), which performs prefetching (step 320). The initialization component, at step 322, launches additional user space processes (e.g., Sysdb 210, agents 212). The user space processes continue startup processing until fully initialized (step 324).

FIG. 3 is merely provided as an illustrative example. Embodiments may, for example, perform the steps in different orders, omit steps, repeat steps, or perform alternative steps.

FIG. 4 is a flow chart illustrating one embodiment of a method of prefetching. The prefetcher (e.g., prefetcher 208), at step 402, reads a list of files to prefetch (e.g., prefetcher list 126). At step 404, the prefetcher reads a file from the list of files. The file is stored in the file cache (e.g., in volatile memory) (step 406). In one embodiment, reading the file causes the file to be decompressed from the compressed file system of the OS image to the file cache (e.g., in volatile memory). The prefetcher can continue to process the list of files until there are no remaining files to prefetch. The prefetcher terminates when prefetching is complete (step 408).

FIG. 4 is merely provided as an illustrative example. Embodiments may, for example, perform the steps in different orders, omit steps, repeat steps, or perform alternative steps.

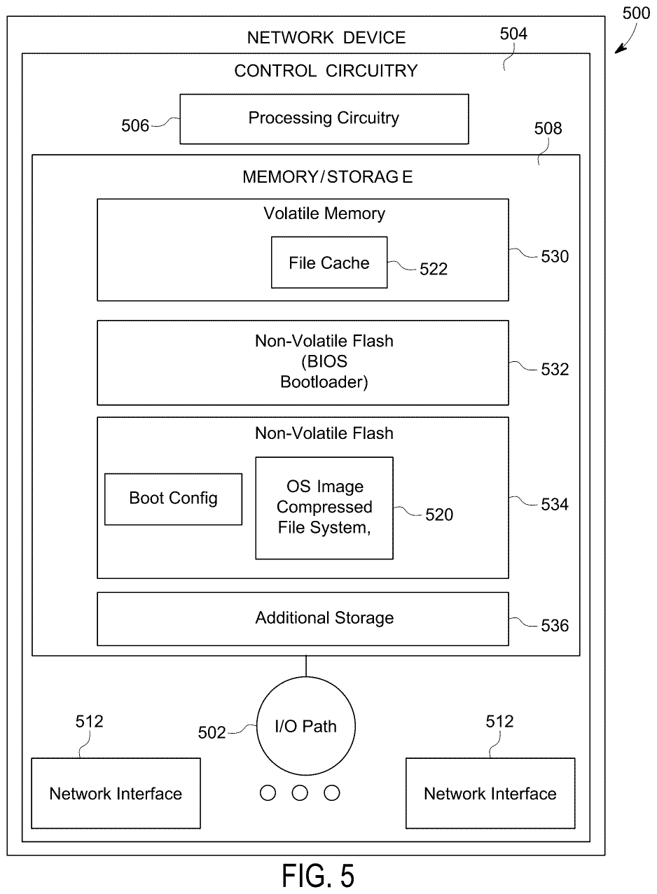

FIG. 5 depicts a diagrammatic representation of an example architecture of a computing device 500, such as a network device (e.g., network device 102), according to some embodiments disclosed herein. Computing device 500 may receive data via an input/output (I/O) path 502. I/O path 502 provides packet data to a control circuitry 504, which includes a processing circuitry 506 and a storage 508 (i.e., memory). Control circuitry 504 may send and receive commands, requests, and other suitable data using the I/O path 502. In turn, I/O path 502 connects the control circuitry 504 (and specifically processing circuitry 506) to one or more network interfaces 512, to which other devices can be connected. These network interfaces may be any type of network interface, such as an RJ45 ethernet port, a coaxial port, etc.

Control circuitry 504 includes processing circuitry 506 and storage 508. As referred to herein, the term “processing circuitry” should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, octa-core, or any suitable number of cores). The prefetcher can be executed on multiple cores. Processing circuitry 506 can be distributed across multiple separate processors or processing units, for example, multiple of the same type of processing units (e.g., two INTEL CORE i7 processors) or multiple different processors (e.g., an INTEL CORE i5 processor and an INTEL CORE i7 processor). The circuitry described herein may execute instructions included in software running on one or more general purpose or specialized processors.

Storage 508 comprises an electronic storage device. As referred to herein, the phrase “electronic storage device” or “storage device” should be understood to mean any device for storing electronic data, computer software, instructions, or firmware, such as RAM, content-addressable memory (CAM) (including a TCAM), hard drives, optical drives, solid state devices, quantum storage devices, or any other suitable fixed or removable storage devices, or any combination of the same. Other implementations may also be possible. In particular, storage 508 includes a volatile RAM 530, which does not retain its contents when power is turned off, and nonvolatile RAM, which does retain its contents when power is turned off. In one embodiment, nonvolatile RAM includes flash memory 532 that stores bootloader instructions and other information used in the earliest stage of the boot process. Flash memory 534, which is preferably much larger in capacity than flash memory 534, stores OS image 520 (e.g., OS image 120). A persistent storage medium 536, such as a hard disk, stores program and file data.

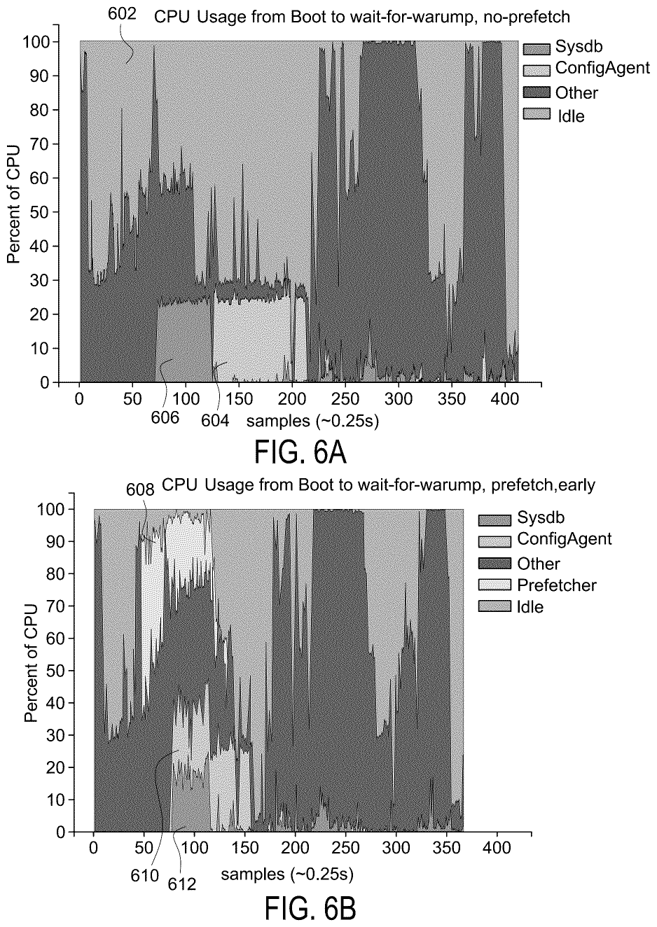

In a particular implementation, for example, flash 532 may be a low-pin-count (LPC) BIOS flash, and flash 534 may be a system flash that holds the run-time software image. Flash 532, according to one embodiment, is written only during manufacturing. The system flash 534, on the other hand, may have the OS image 520 as written during manufacturing or updated in the field. OS image 520 includes a prefetcher that causes files that will be used by other user space processes of the OS to be prefetched into a file cache 522. FIG. 6A is a chart illustrating CPU usage of a four core CPU during boot without a prefetcher. As illustrated, there is a considerable amount of idle CPU capacity 602. Additionally, ConfigAgent loading (represented at region 604) is blocked until after significant processing by Sysdb (represented by region 606).

In FIG. 6B, a prefetcher is launched (represented at region 608) before ConfigAgent and Sysdb. The prefetcher uses the extra CPU cycles and unused I/O capacity to prefetch files that will be used by ConfigAgent and Sysdb to the file cache. Thus, ConfigAgent processing (represented at region 610) can begin earlier in the process in parallel with Sysdb processing (represented by region 612) The prefetcher, in this example, reduces the time to load ConfigAgent by ˜15 seconds compared to FIG. 6A.

In this disclosure, specific embodiments have been described with reference to the accompanying figures. In the above description, numerous details are set forth as examples. It will be understood by those skilled in the art, and having the benefit of this Detailed Description, that one or more embodiments described herein may be practiced without these specific details and that numerous variations or modifications may be possible without departing from the scope of the embodiments. Certain details known to those of ordinary skill in the art may be omitted to avoid obscuring the description.

In the above description of the figures, any component described with regard to a figure, in various embodiments, may be equivalent to one or more like-named components shown and/or described with regard to any other figure. For brevity, descriptions of these components may not be repeated with regard to each figure. Thus, each and every embodiment of the components of each figure is incorporated by reference and assumed to be optionally present within every other figure having one or more like-named components. Additionally, in accordance with various embodiments described herein, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for booting a computing system, comprising:
during a boot sequence, launching a prefetcher from an operating system (OS) image for an OS;
reading, by the prefetcher, a prefetcher list that specifies a plurality of files to be prefetched; and
reading the plurality of files specified by the prefetcher list to cause the plurality of files to be copied from a filesystem to a file cache to prefetch the plurality of files for a startup of a user space process of the OS.

2. The method of claim 1, wherein the filesystem is a compressed filesystem and wherein the plurality of files are decompressed for storing in the file cache.

3. The method of claim 1, wherein the prefetcher is launched by an initialization component of the operating system.

4. The method of claim 3, wherein the initialization component of the operating system launches the prefetcher prior to launching the user space process.

5. The method of claim 1, wherein the operating system is a network device operating system.

6. The method of claim 1, wherein the prefetcher executes in parallel with at least one other boot process.

7. The method of claim 1, wherein the prefetcher list is created from a trace of files loaded by the user space process at build time.

8. A computer program product comprising a non-transitory, computer-readable medium storing an operating system (OS) image file, the OS image file comprising:
a filesystem comprising program files for an OS, the program files for the OS comprising:
a prefetcher list;
a prefetcher comprising instructions executable for:
reading the prefetcher list to determine a plurality of files to prefetch; and
during a boot sequence, reading the plurality of files to prefetch the plurality of files from the filesystem to a file cache to prefetch the plurality of files for a startup of a user space process of the operating system.

9. The computer program product of claim 8, wherein the wherein the filesystem is a compressed filesystem and wherein the plurality of files are decompressed for storing in the file cache.

10. The computer program product of claim 8, wherein the OS comprises an initialization component executable to launch the prefetcher prior to launching the user space process.

11. The computer program product of claim 8, wherein the OS is a network device operating system.

12. The computer program product of claim 8, wherein the prefetcher is executable in parallel with at least one other boot process.

13. The computer program product of claim 8, wherein the prefetcher list is derived from a trace of files loaded by the user space process at build time.

14. A computing device comprising:
a processor;
a volatile random access memory;
a first flash memory, the first flash memory storing an operating system (OS) image, the OS image comprising a filesystem comprising program files for an OS, the program files for the OS comprising:
a prefetcher list;
a prefetcher comprising instructions executable for:
reading the prefetcher list to determine a plurality of files to prefetch; and
during a boot sequence, reading the plurality of files to prefetch the plurality of files from the filesystem to a file cache in the volatile random access memory to prefetch the plurality of files for a startup of a user space process of the operating system.

15. The computing device of claim 14, further comprising a second flash memory, the second flash memory storing a bootloader, the bootloader comprising instructions to locate the OS image and load at least a portion of a kernel of the OS.

16. The computer device of claim 15, wherein the OS comprises an initialization component, wherein the initialization component is executable to load the prefetcher prior to loading the user space process.

17. The computing device of claim 14, wherein the filesystem is a compressed filesystem and wherein the plurality of files are decompressed for storing in the file cache.

18. The computing device of claim 14, wherein the computing device is a network device.

19. The computing device of claim 14, wherein the prefetcher is executable in parallel with at least one other boot process.

20. The computing device of claim 14, wherein the prefetcher is executable to run in user space.
